(19) United States
(12) Patent Application Publication
(10) Pub. No.: US 2003/0082037 A1
(43) Pub. Date: May 1, 2003

(54) Combination roll-off bed and grapple arm for mounting to a chassis of a truck

(76) Inventor: Sergey Vladimirovich Khodkov, Holtsville, NY (US)

Correspondence Address: Sergey Vladimirovich Khodkov, 73 Matsunaye Drive, Medford, NY, 11763, US

(21) Appl. No.: 10/046,493

(22) Filed: Oct. 27, 2001

(51) Int. Cl. B60P 1/00; B65G 67/02

(52) U.S. Cl. 414/546; 414/498; 414/542

(57) ABSTRACT

A combination roll-off bed and grapple arm for mounting to a chassis of a truck. The combination includes a bed, a roll-off bed, and a grapple arm. The bed is affixed onto the chassis of the truck and tilts relative to the chassis of the truck. The roll-off bed is longitudinally movably mounted to the bed. The grapple arm is longitudinally and rotatably movably mounted to the bed.

### BACKGROUND OF THE INVENTION

1. Field of the Invention

The present invention relates to a combination roll-off bed and grapple arm. More particularly, the present invention relates to a combination roll-off bed and grapple arm for mounting to a chassis of a truck.

2. Description of the Prior Art

Numerous innovations for loading arms have been provided in the prior art that will be described. Even though these innovations may be suitable for the specific individual purposes to which they address, however, they differ from the present invention.

FOR EXAMPLE, U.S. Pat. No. 4,175,903 to Carson teaches a pick-up apparatus and a container that are specially designed to facilitate the lifting of the container and the dumping of its contents. The container includes a frame which has tubular frame members extending between the top and bottom of the container, and a cover is hingedly mounted on the top of the container and can be releasably latched in a closed position by an inertia latch. The pick-up apparatus includes a boom, a pick-up arm mounted on the boom for articulation in a generally horizontal plane, and a pair of clamping arms mounted on the end of the pick-up arm. The clamping arms are slidably mounted on the pick-up arm, and the spacing between the arms can be varied by hydraulic cylinders on the pick-up arm. Each of the clamping arms includes a clamping pad which includes a plurality of flexible, resilient cone-shaped projections which are sized and spaced so that the tubular frame members of the container can be received between the ends of adjacent projections.

ANOTHER EXAMPLE, U.S. Pat. No. 5,060,532 to Barker teaches a universal joint boom assembly comprising two boom segments having paired eared ends connected end to end by means of a universal joint with one of its set of ears parallel to an X axis and the other set of ears parallel to a Y axis which is perpendicular to the X axis. An offset X axis hydraulic assembly and an offset Y axis hydraulic assembly interconnects the boom segments to cause pivoting of the boom universal joint so as to lean a boom segment in the direction of the X and Y axes respectively.

STILL ANOTHER EXAMPLE, U.S. Pat. No. 5,391,039 to Holtom teaches a bin grabbing nipper of a refuse loader arm that is held at a constant angle to limb by a parallelogram linkage having pivots. Thus, pivoting of limb leads directly to inversion of the raised bin and no separate operation of a special bin tilting ram is required to bring a bin to dumping position. The nipper consists of two opposed, jointed fingers which are separately pivoted to a wrist member. All finger joints and wrist joints of the nipper are pivoted by separate hydraulic cylinders supplied by a common source. By sensing back-pressure in each cylinder they can be made to exert equal force. Pivoting at limb joints and is by opposed hydraulic cylinders acting on a rack meshing with a gear wheel. Both these joints may be controlled by a single joystick.

YET ANOTHER EXAMPLE, U.S. Pat. No. 5,601,392 to Smith et al. teaches a device for lifting and loading materials that employs a pick-up arm for engaging material at ground level and an associated lift arm assembly. The pick-up arm can be swung relative to the lift arm about an axis that is generally perpendicular to the ground to bring the pick-up arm into a close-in position in front of a cab and into an outreaching position. The pick-up arm is automatically moved into the outreaching position as the lift arm moves toward a ground level load position and is automatically moved into the close-in position as the lift arm moves toward the off-load level above ground to facilitate off-loading operations above ground. The pick-up arm is also automatically maintained in a desired vertical relationship, parallel to the ground, as the lift arm moves between the load level and a predetermined level above ground level. When moved closer toward the off-load position, the pick-up arm is automatically vertically tipped to facilitate off-loading operations. The lift assembly can be controlled by a single operator using a single control lever. The lift arm can also be pivoted between a position next to the cab and a second position angularly spaced to one side of the cab. This can also be controlled by the single operator using the single control lever.

STILL YET ANOTHER EXAMPLE, U.S. Pat. No. 5,755,547 to Flerchinger et al. teaches a side loading refuse collection vehicle having a carriage slidably mounted on a track and pivotally carrying a lift arm assembly including refuse container grabbing and dumping apparatus for grabbing a refuse container, lifting it and dumping it into the body of the vehicle includes a keeper plate secured to the carriage and a detent latch pivotally mounted on the frame for seizing and holding the keeper selectively. The carriage is slidably driven by a hydraulic cylinder assembly to extend and retract the carriage relative to the vehicle, and whenever the hydraulic cylinder assembly is actuated by an operator control switch the latch disengages from the keeper. When the hydraulic cylinder assembly is not actuated, the latch engages and holds the keeper and thereby prevents the lift arm from being flung outwardly in the event of a failure in the hydraulic cylinder assembly system.

YET STILL ANOTHER EXAMPLE, U.S. Pat. No. 5,769,594 to Kalua teaches a truck-mounted pickup arm assembly for collecting, lifting, and placing objects and trash and recycling materials in the truck that includes three boom sections to facilitate articulation of the arm in complex configurations to extend to the front or side of the truck, to reach over obstacles, and to pick up articles and materials and place them into a top loading opening in the truck. The pickup arm assembly includes a turntable mounted on the truck bed adjacent to and rearwardly of the truck cab. A main boom is pivotally secured to the turntable on a horizontal pivot axis, so that the main boom may pivot through approximately 180.degree. in the space between the truck cab and the truck body. A coupling assembly is joined about one axis to the upper end of the main boom, and an intermediate boom is joined to the coupling about another, orthogonal axis. An outer boom is pivotally joined at one end in to a clevis end of the intermediate boom. A clamshell assembly is pivotally secured to the outer end of the outer boom. The turntable is power-driven, and all booms and the clamshell assembly are each manipulated by a power assist device. In a further embodiment, the turntable is supported on laterally extending rails or guides, so that the turntable may be translated laterally to either side of the truck bed. In another embodiment, a rail support extends longitudinally along the upper surface of the truck body and truck cab. A multi-boom pickup arm assembly is supported on a carriage that is adapted to travel along the rail support to permit the pickup arm assembly to engage objects and articles in the front or rear of the truck. In another aspect of the invention, a pickup arm assembly is supported by paired, laterally opposed arms pivotally joined on either side of the truck body to move the arm forwardly or rearwardly.

STILL YET ANOTHER EXAMPLE, U.S. Pat. No. 6,004,092 to Johnson et al. teaches a side loading refuse collection vehicle that has a lift arm extendible and rotatable relative to the vehicle, the lift arm carrying grabber apparatus at an end for grasping a refuse container which may be lifted and dumped into the top of the body of the vehicle. The lift arm which is guided to move in a path so as to grasp the container, raise it, dump it and return it to its initial position, is driven toward and away from the vehicle by a first hydraulic drive cylinder and lifted and lowered by a second hydraulic drive cylinder. The first hydraulic drive cylinder has a drive rod on which a locking bolt is secured and may be captured in a receptacle of a keeper when the rod is in the fully retracted position to lock the arm against inadvertent and undesirable extension outwardly away from the vehicle. The keeper is pivotally mounted and moved by the output rod of a pneumatic cylinder to permit the bolt to be released from the receptacle when the hydraulic drive is activated. When the hydraulic drive rod is retracted to its fully retracted position, the keeper returns to the locking position to receive the locking bolt. This ensures that the arm does not inadvertently drift outwardly into traffic while the vehicle is driven should there be a failure of the hydraulic cylinder system.

It is apparent that numerous innovations for loading arms have been provided in the prior art that are adapted to be used. Furthermore, even though these innovations may be suitable for the specific individual purposes to which they address, however, they would not be suitable for the purposes of the present invention as heretofore described.

### SUMMARY OF THE INVENTION

ACCORDINGLY, AN OBJECT of the present invention is to provide a combination roll-off bed and grapple arm for mounting to a chassis of a truck that avoids the disadvantages of the prior art.

ANOTHER OBJECT of the present invention is to provide a combination roll-off bed and grapple arm for mounting to a chassis of a truck that is simple to use.

BRIEFLY STATED, STILL ANOTHER OBJECT of the present invention is to provide a combination roll-off bed and grapple arm for mounting to a chassis of a truck. The combination includes a bed, a roll-off bed, and a grapple arm. The bed is affixed onto the chassis of the truck and tilts relative to the chassis of the truck. The roll-off bed is longitudinally movably mounted to the bed. The grapple arm is longitudinally and rotatably movably mounted to the bed.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawing.

### BRIEF DESCRIPTION OF THE DRAWING

The figures of the drawing are briefly described as follows:

FIG. 1 is a diagrammatic side elevational view of the combination roll-off bed and grapple arm mounted to a chassis of a truck;

FIG. 2 is an enlarged diagrammatic side elevational view of the area generally enclosed by the dotted curve identified by ARROW 2 in FIG. 1 of the combination roll-off bed and grapple arm of the present invention shown in FIG. 1; and

FIG. 3 is an enlarged diagrammatic side elevational view of the area generally enclosed by the dotted curve identified by ARROW 3 in FIG. 2 of the grapple arm of the combination roll-off bed and grapple arm of the present invention shown in FIG. 2.

### LIST OF REFERENCE NUMERALS UTILIZED IN THE DRAWING

10 combination roll-off bed and grapple arm of present invention for mounting to chassis 12 of truck 14

12 chassis of truck 14

14 truck

16 bed for affixing onto, and tilting relative to, chassis 12 of truck 14

18 roll-off bed

20 grapple arm

22 frame of bed 16 for affixing onto chassis 12 of truck 14

24 forwardmost end of frame 22 of bed 16

26 rearwardmost end of frame 22 of bed 16

27 pair of longitudinal rails of frame 22 of bed 16

28 brackets 28 of bed 16 for affixing the frame 22 of bed 16 onto chassis 12 of truck 14

30 pair of front stabilizer cylinders of frame 22 of bed 16 for engaging ground 32

32 ground

34 pair of rear stabilizer cylinders 34 of frame 22 of bed 16 for engaging ground 32

36 dump cylinder of bed 16

38 cable of bed 16 for engaging, and advancing, container (not shown) onto bed 16

40 pulley of bed 16

42 roll-off cylinder 42 of roll-off bed 18

44 lock brackets of roll-off bed 18

46 rearwardmost end of roll-off bed 18

48 ground roller on rearwardmost end 46 of roll-off bed 18

50 hose roller on rearwardmost end 46 of roll-off bed 18

52 carriage of grapple arm 20

54 ring gear of grapple arm 20

56 stand of grapple arm 20

58 lowermost end of stand 56 of grapple arm 20

60 uppermost end of stand 56 of grapple arm 20

62 lift cylinder of grapple arm 20

64 arm of grapple arm 20

66 uppermost end of arm 64 of grapple arm 20

68 swing cylinder of grapple arm 20

70 slade of grapple arm 20

72 uppermost end of slade 70 of grapple arm 20

74 tilt cylinder of grapple arm 20

76 fork of grapple arm 20

78 slide cylinder of grapple arm 20

80 arms of fork 76 of grapple arm 20 for engaging container (not shown)

### DETAILED DESCRIPTION OF THE PREFERRED EMBODIMENT

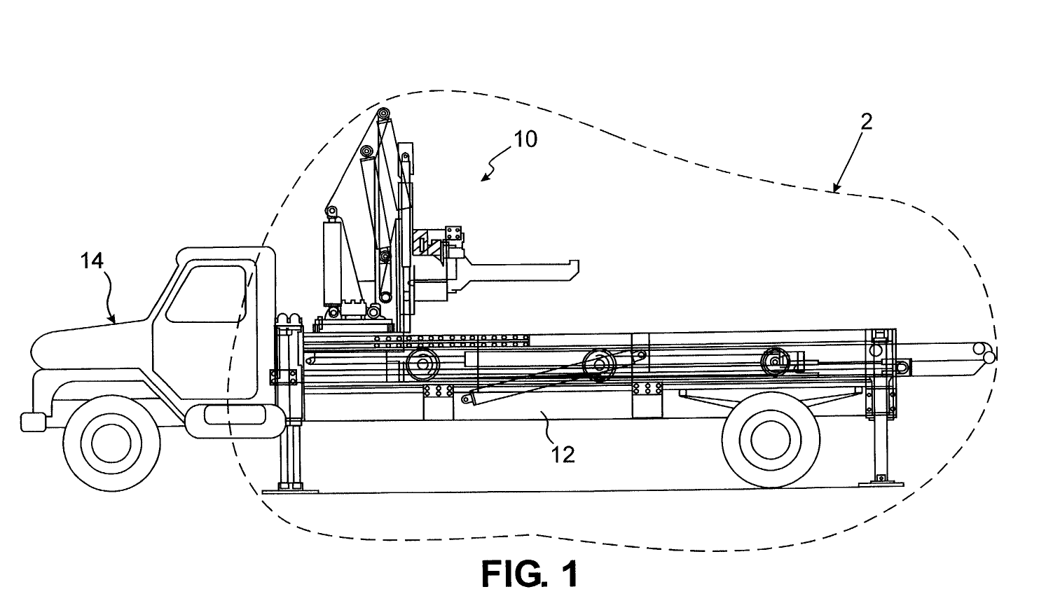

Referring now to the figures, in which like numerals indicate like parts, and particularly to FIG. 1, which is a diagrammatic side elevational view of the combination roll-off bed and grapple arm mounted to a chassis of a truck, the combination roll-off bed and grapple arm of the present invention is shown generally at 10 for mounting to a chassis 12 of a truck 14.

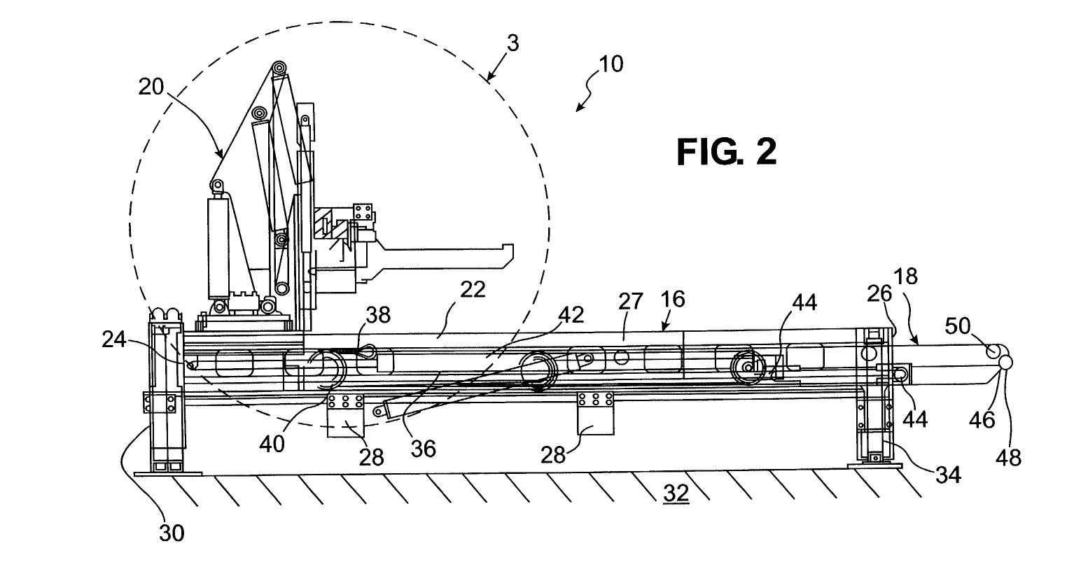

The overall configuration of the combination roll-off bed and grapple arm 10 can best be seen in FIG. 2, which is an enlarged diagrammatic side elevational view of the area generally enclosed by the dotted curve identified by ARROW 2 in FIG. 1 of the combination roll-off bed and grapple arm of the present invention shown in FIG. 1, and as such, will be discussed with reference thereto.

The combination roll-off bed and grapple arm 10 comprises a bed 16 for affixing onto, and tilting relative to, the chassis 12 of the truck 14, a roll-off bed 18 that is longitudinally movably mounted to the bed 16, and a grapple arm 20 that is longitudinally and rotatably movably mounted to the bed 16.

The specific configuration of the bed 16 and the roll-off bed 18 can best be seen in FIG. 2, and as such, will be discussed with reference thereto.

The bed 16 comprises a frame 22 that has a forwardmost end 24, a rearwardmost end 26, a pair of longitudinal rails 27, and is for affixing onto the chassis 12 of the truck 14, and brackets 28 for affixing the frame 22 of the bed 16 onto the chassis 12 of the truck 14.

The frame 22 of the bed 16 has a pair of front stabilizer cylinders 30 that depend from the forwardmost end 24 of the frame 22 of the bed 16 and are for engaging the ground 32, and pair of rear stabilizer cylinders 34 that depend from the rearwardmost end 26 of the frame 22 of the bed 16 and are for engaging the ground 32.

The bed 16 is tiltably attached to the rearwardmost end 26 of the frame 22 of the bed 16, and is tilted by a dump cylinder 36 that is disposed intermediate the forwardmost end 24 of the frame 22 of the bed 16 and the rearwardmost end 26 of the frame 22 of the bed 16 and is pivotally mounted to the bed 16 and the frame 22 of the bed 16.

The bed 16 further has a cable 38 that is reeved around a pulley 40 that is disposed in close proximity to the forwardmost end 24 of the frame 22 of the bed 16 and is extendable rearwardly therefrom to over the roll-off bed 18 for engaging, and advancing, a container (not shown) onto the bed 16.

The roll-off bed 18 is longitudinally movable in the frame 22 of the bed 16 so as to be extendable therefrom and retractable therein by a roll-off cylinder 42 that is operatively connected to the frame 22 of the bed 16 and the roll-off bed 18.

The roll-off bed 18 has lock brackets 44 that are operatively connected to the frame 22 of the bed 16 and the roll-off bed 18 and lock the roll-off bed 18 at a desired position relative to the frame 22 of the bed 16, and a rearwardmost end 46 with a ground roller 48 and a hose roller 50 thereon.

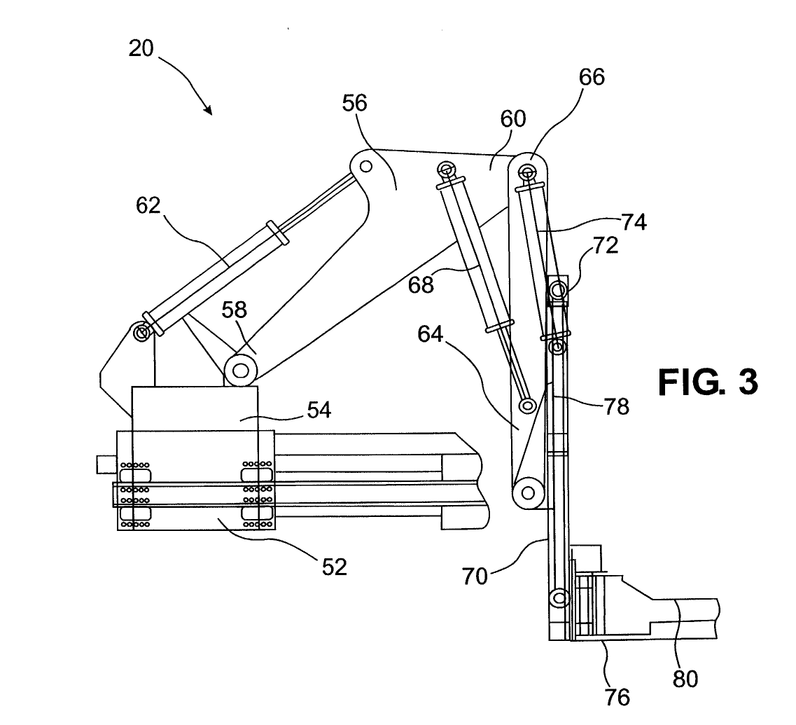

The specific configuration of the grapple arm 20 can best be seen in FIG. 3, which is an enlarged diagrammatic side elevational view of the area generally enclosed by the dotted curve identified by ARROW 3 in FIG. 2 of the grapple arm of the combination roll-off bed and grapple arm of the present invention shown in FIG. 2, and as such, will be discussed with reference thereto.

The grapple arm 20 comprises a carriage 52 that slides longitudinally along the pair of longitudinal rails 27 of the frame 22 of the bed 16 and allows the grapple arm 20 to move back and forth along the bed 16.

The grapple arm 20 further comprises a ring gear 54 that is mounted to the carriage 52 of the grapple arm 20 and allows the grapple arm 20 to rotate 360° relative to the bed 16.

The grapple arm 20 further comprises a stand 56 that has a lowermost end 58 that is pivotally mounted to the carriage 52 of the grapple arm 20 and an uppermost end 60.

The grapple arm 20 further comprises a lift cylinder 62 that is pivotally mounted to the carriage 52 of the grapple arm 20 and to the stand 56 of the grapple arm 20 and allows the grapple arm 20 to pivot up and down.

The grapple arm 20 further comprises an arm 64 that has an uppermost end 66 that is pivotally mounted to the uppermost end 60 of the stand 56 of the grapple arm 20.

The grapple arm 20 further comprises a swing cylinder 68 that is pivotally mounted to the stand 56 of the grapple arm 20 and to the arm 64 of the grapple arm 20 and allows the grapple arm 20 to swing forward and backward.

The grapple arm 20 further comprises a slade 70 that is pivotally mounted to the arm 64 of the grapple arm 20 and has an uppermost end 72.

The grapple arm 20 further comprises a tilt cylinder 74 that is pivotally mounted to the uppermost end 66 of the arm 64 of the grapple arm 20 and to the uppermost end 72 of the slade 70 of the grapple arm 20 and allows the slade 70 of the grapple arm 20 to tilt forward and backward.

The grapple arm 20 further comprises a fork 76 that is slidably mounted to the slade 70 of the grapple arm 20 and is movable up and down therealong.

The grapple arm 20 further comprises a slide cylinder 78 that is mounted to the slade 70 of the grapple arm 20 and to the fork 76 of the grapple arm 20 and allows the fork 76 of the grapple arm 20 to slide up and down along the slade 70 of the grapple arm 20.

The fork 76 of the grapple arm 20 has arms 80 that extend therefrom for engaging a container (not shown), and which pivot inward thereagainst for storage.

It will be understood that each of the elements described above, or two or more together, may also find a useful application in other types of constructions differing from the types described above.

While the invention has been illustrated and described as embodied in a combination roll-off bed and grapple arm for mounting to a chassis of a truck, however, it is not limited to the details shown, since it will be understood that various omissions, modifications, substitutions and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

The invention claimed is:

1. A combination roll-off bed and grapple arm for mounting to a chassis of a truck, comprising:
a) a bed;
b) a roll-off bed; and
c) a grapple arm;
wherein said bed is for affixing onto the chassis of the truck;
wherein said bed is for tilting relative to the chassis of the truck;
wherein said roll-off bed is longitudinally movably mounted to said bed;
wherein said grapple arm is longitudinally movably mounted to said bed; and
wherein said grapple arm is rotatably movably mounted to said bed.

2. The combination as defined in claim 1, wherein said bed comprises a frame;
wherein said frame of said bed has a forwardmost end;
wherein said frame of said bed has a rearwardmost end;
wherein said frame of said bed has a pair of longitudinal rails;
wherein said frame of said bed is for affixing onto the chassis of the truck;
wherein said bed comprises brackets; and
wherein said brackets of said bed are for affixing said frame of said bed onto the chassis of the truck.

3. The combination as defined in claim 2, wherein said frame of said bed has a pair of front stabilizer cylinders;
wherein said pair of front stabilizer cylinders of said frame of said bed depend from said forwardmost end of said frame of said bed;
wherein said pair of front stabilizer cylinders of said frame of said bed are for engaging the ground;
wherein said frame of said bed has a pair of rear stabilizer cylinders;
wherein said pair of rear stabilizer cylinders of said frame of said bed depend from said rearwardmost end of said frame of said bed; and
wherein said pair of rear stabilizer cylinders of said frame of said bed are for engaging the ground.

4. The combination as defined in claim 2, wherein said bed is tiltably attached to said rearwardmost end of said frame of said bed;
wherein said bed is tilted by a dump cylinder;
wherein said dump cylinder of said bed is disposed intermediate said forwardmost end of said frame of said bed and said rearwardmost end of said frame of said bed; and wherein said dump cylinder of said bed is pivotally mounted to said bed and said frame of said bed.

5. The combination as defined in claim 2, wherein said bed has a cable;
wherein said cable of said bed is reeved around a pulley of said bed;
wherein said pulley of said bed is disposed in close proximity to said forwardmost end of said frame of said bed;
wherein said cable of said bed is extendable rearwardly from said pulley of said bed to over said roll-off bed;
wherein said cable of said bed is for engaging a container; and
wherein said cable of said bed is for advancing the container onto said bed.

6. The combination as defined in claim 2, wherein said roll-off bed is longitudinally movable in said frame of said bed;
wherein said roll-off bed is extendable from said frame of said bed and retractable into said frame of said bed by a roll-off cylinder; and
wherein said roll-off cylinder of said roll-offbed is operatively connected to said frame of said bed and said roll-off bed.

7. The combination as defined in claim 2, wherein said roll-off bed has lock brackets;
wherein said lock brackets of said roll-off bed are operatively connected to said frame of said bed and said roll-off bed; and
wherein said lock brackets of said roll-off bed lock said roll-off bed at a desired position relative to said frame of said bed.

8. The combination as defined in claim 1, wherein said wherein said roll-off bed has a rearwardmost end;
wherein said rearwardmost end of said roll-off bed has a ground roller thereon; and
wherein said rearwardmost end of said roll-off bed has a hose roller thereon.

9. The combination as defined in claim 2, wherein said grapple arm comprises a carriage;
wherein said carriage of said grapple arm slides longitudinally along said pair of longitudinal rails of said frame of said bed; and
wherein said carriage of said grapple arm allows said grapple arm to move back and forth along said bed.

10. The combination as defined in claim 9, wherein said grapple arm comprises a ring gear;
wherein said ring gear of said grapple arm is mounted to said carriage of said grapple arm; and
wherein said ring gear of said grapple arm allows said grapple arm to rotate 360° relative to said bed.

11. The combination as defined in claim 9, wherein said grapple arm comprises a stand;
wherein said stand of said grapple arm has a lowermost end;
wherein said lowermost end of said stand of said grapple arm is pivotally mounted to said carriage of said grapple arm; and
wherein said stand of said grapple arm has an uppermost end.

12. The combination as defined in claim 11, wherein said grapple arm comprises a lift cylinder;
wherein said lift cylinder of said grapple arm is pivotally mounted to said carriage of said grapple arm;
wherein said lift cylinder of said grapple arm is pivotally mounted to said stand of said grapple arm; and
wherein said lift cylinder of said grapple arm allows said grapple arm to pivot up and down.

13. The combination as defined in claim 11, wherein said grapple arm comprises an arm;
wherein said arm of said grapple arm has an uppermost end; and
wherein said uppermost end of said arm of said grapple arm is pivotally mounted to said uppermost end of said stand of said grapple arm.

14. The combination as defined in claim 13, wherein said grapple arm comprises a swing cylinder;
wherein said swing cylinder of said grapple arm is pivotally mounted to said stand of said grapple arm;
wherein said swing cylinder of said grapple arm is pivotally mounted to said arm of said grapple arm; and
wherein said swing cylinder of said grapple arm allows said grapple arm to swing forward and backward.

15. The combination as defined in claim 13, wherein said grapple arm comprises a slade;
wherein said slade of said grapple arm is pivotally mounted to said arm of said grapple arm; and
wherein said slade of said grapple arm has an uppermost end.

16. The combination as defined in claim 15, wherein said grapple arm comprises a tilt cylinder;
wherein said tilt cylinder of said grapple arm is pivotally mounted to said uppermost end of said arm of said grapple arm;
wherein said tilt cylinder of said grapple arm is pivotally mounted to said uppermost end of said slade of said grapple arm; and
wherein said tilt cylinder of said grapple arm allows said slade of said grapple arm to tilt forward and backward.

17. The combination as defined in claim 15, wherein said grapple arm comprises a fork;
wherein said fork of said grapple arm is slidably mounted to said slade of said grapple arm; and
wherein said fork of said grapple arm is movable up and down along said slade of said grapple arm.

18. The combination as defined in claim 17, wherein said grapple arm comprises a slide cylinder;
wherein said slide cylinder of said grapple arm is mounted to said slade of said grapple arm;
wherein said slide cylinder of said grapple arm is mounted to said to said fork of said grapple arm; and
wherein said slide cylinder of said grapple arm allows said fork of said grapple arm to slide up and down along said slade of said grapple arm.

19. The combination as defined in claim 17, wherein said fork of said grapple arm has arms;
wherein said arms of said fork of said grapple arm extend from said fork of said grapple arm;
wherein said arms of said fork of said grapple arm are for engaging a container; and
wherein said arms of said fork of said grapple arm pivot inward against said fork of said grapple arm for storage.
